(19) United States
(12) Patent Application Publication
(10) Pub. No.: US 2024/0157617 A1
(43) Pub. Date: May 16, 2024

(54) CONTROL DEVICE OF INJECTION MOLDING MACHINE, INJECTION MOLDING MACHINE, AND METHOD OF CONTROLLING INJECTION MOLDING MACHINE

(71) Applicant: SUMITOMO HEAVY INDUSTRIES, LTD., Tokyo (JP)

(72) Inventors: Takuya MATSUNAGA, Chiba-shi (JP); Keisuke TOMIMATSU, Chiba-shi (JP); Katsuki FUJITA, Chiba-shi (JP); Shun SHIBUYA, Chiba-shi (JP); Xiangyu CHU, Chiba-shi (JP)

(21) Appl. No.: 18/482,882

(22) Filed: Oct. 8, 2023

(30) Foreign Application Priority Data
Nov. 16, 2022 (JP) 2022-183083

(51) Int. Cl. B29C 45/76; B29C 45/17

(52) U.S. Cl. CPC B29C 45/7653; B29C 45/1774; B29C 2945/7601; B29C 2945/76501; B29C 2945/76709; B29C 2945/76862

(57) ABSTRACT

A control device includes: an injection control unit that controls, in a pressure holding process of controlling a pressure acting on a molding material from an injection member, an injection drive source based on a set value of the pressure and an actual value of the pressure. The injection control unit performs pressure reduction control to gradually reduce the actual value of the pressure with respect to the set value of the pressure from a middle of a k-th stage (k is an integer of 1 or more and n or less). The control device includes a ratio setting unit that sets a time ratio Tr(k) in the k-th stage and a pressure ratio ΔPr(k) in the k-th stage based on a set value P(k) of the pressure in the k-th stage, a set value T(k) of a holding time in the k-th stage, and information stored in advance.

### CROSS-REFERENCE TO RELATED APPLICATIONS

This application claims priority to Japanese Patent Application No. 2022-183083, filed on Nov. 16, 2022, which is incorporated by reference herein in its entirety.

### BACKGROUND

### Technical Field

Certain embodiments of the present invention relate to a control device of an injection molding machine, an injection molding machine, and a method of controlling an injection molding machine.

### Description of Related Art

An injection molding machine in the related art includes a screw that presses a molding material, an injection motor that moves the screw, and a control device that controls the injection motor. The control device gradually reduces an output of the injection motor in order to reduce power consumption of the injection motor in a pressure holding process of controlling a pressure acting on the molding material from the screw.

### SUMMARY

According to an embodiment of the present invention, there is provided a control device of an injection molding machine including an injection member that presses a molding material and an injection drive source that moves the injection member. The control device includes an injection control unit that controls, in a pressure holding process of controlling a pressure acting on the molding material from the injection member, the injection drive source based on a set value of the pressure and on an actual value of the pressure. The pressure holding process has n stages (n is an integer of 1 or more) of combinations of set values of the pressure and holding times for holding the set values. The injection control unit performs pressure reduction control to gradually reduce the actual value of the pressure with respect to the set value of the pressure from a middle of a k-th stage (k is an integer of 1 or more and n or less). The control device includes a ratio setting unit that sets a time ratio Tr(k) in the k-th stage and a pressure ratio ΔPr(k) in the k-th stage based on a set value P(k) of the pressure in the k-th stage, on a set value T(k) of the holding time in the k-th stage, and on information stored in advance. Tr(k) is a ratio of a start time Ta(k) at which the pressure reduction control starts in the k-th stage to the set value T(k) of the holding time in the k-th stage. ΔPr(k) is a ratio of a difference ΔPa(k) between the actual value of the pressure at an end of the k-th stage and a reference value to a difference ΔP(k) between the set value P(k) of the pressure in the k-th stage and the reference value.

### BRIEF DESCRIPTION OF THE DRAWINGS

FIG. 1 is a view showing a state when mold opening is completed in an injection molding machine according to an embodiment of the present invention.

FIG. 2 is a view showing a state when mold clamping is performed in the injection molding machine according to the embodiment.

FIG. 3 is a functional block diagram showing an example of components of a control device.

FIG. 4 is a diagram showing an example of processes of a molding cycle.

FIG. 5 is a diagram showing an example of a change in a set value of a pressure and in an actual value of the pressure in a pressure holding process.

FIG. 6 is a diagram showing an example of a screen for manually setting a time ratio and a pressure ratio.

FIG. 7 is a diagram showing an example of a screen for automatically setting the time ratio and the pressure ratio.

FIG. 8 is a flowchart showing an example of a method of setting the time ratio.

FIG. 9 is a flowchart showing an example of a method of setting the pressure ratio.

FIG. 10 is a diagram showing an example of a condition in which the pressure ratio becomes negative.

### DETAILED DESCRIPTION

The related art describes that a user of an injection molding machine inputs a condition (parameter) for gradually reducing the output of the injection motor to an input device. In a case where the parameter is inappropriate, quality of a molding product is decreased. It is necessary to determine the parameter so that the quality of the molding product can be maintained, which imposes a heavy burden on the user.

It is desirable to provide a technique for reducing burdens of a user of an injection molding machine.

According to an embodiment of the present invention, a parameter used for the pressure reduction control can be automatically set, and a burden on the user of the injection molding machine can be reduced.

Hereinafter, embodiments of the present invention will be described with reference to the drawings. In each drawing, the same reference numerals will be assigned to the same or corresponding configurations, and description thereof will be omitted.

### Injection Molding Machine

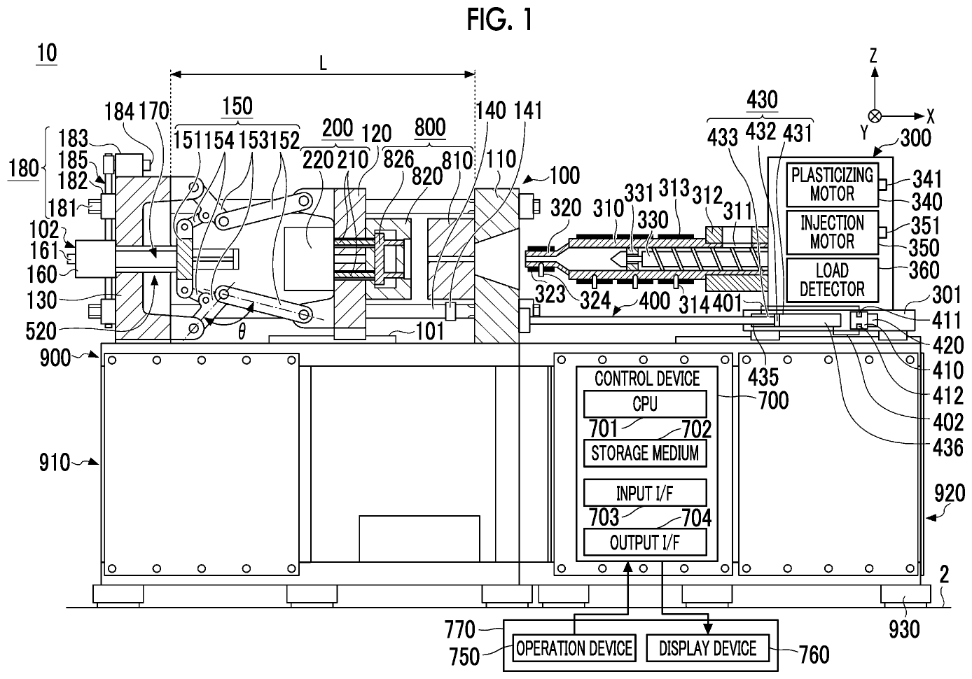

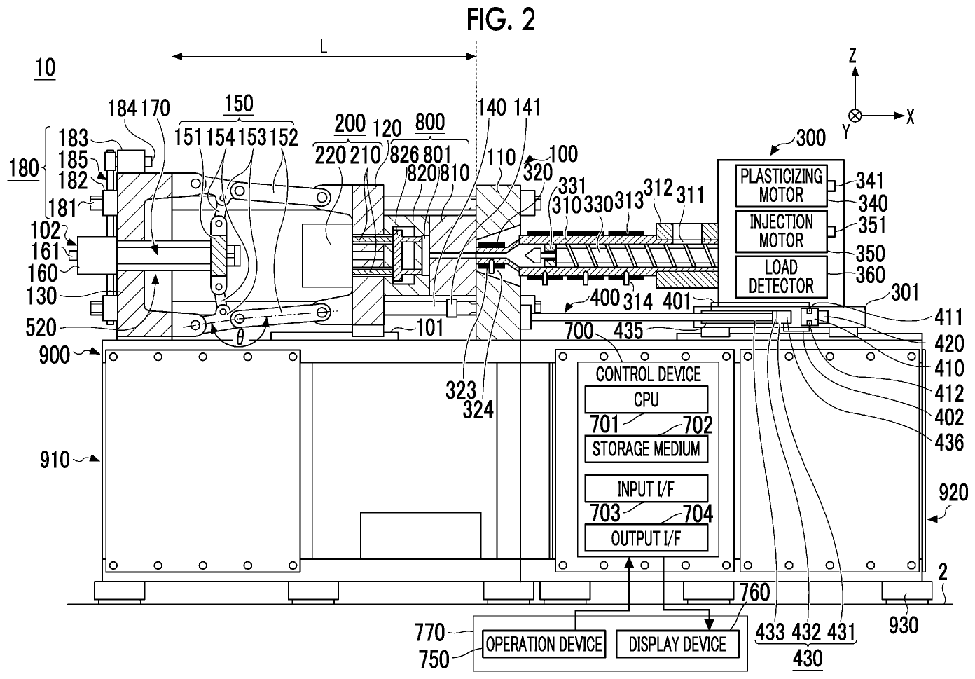

FIG. 1 is a view showing a state when mold opening is completed in an injection molding machine according to an embodiment. FIG. 2 is a view showing a state when mold clamping is performed in the injection molding machine according to the embodiment. In the present specification, an X-axis direction, a Y-axis direction, and a Z-axis direction are perpendicular to each other. The X-axis direction and the Y-axis direction represent a horizontal direction, and the Z-axis direction represents a vertical direction. In a case where a mold clamping unit 100 is of a horizontal type, the X-axis direction represents a mold opening and closing direction, and the Y-axis direction represents a width direction of an injection molding machine 10. A negative side in the Y-axis direction will be referred to as an operation side, and a positive side in the Y-axis direction will be referred to as a counter-operation side.

As shown in FIGS. 1 and 2, the injection molding machine 10 includes the mold clamping unit 100 that opens and closes a mold unit 800, an ejector unit 200 that ejects a molding product molded by the mold unit 800, an injection unit 300 that injects a molding material into the mold unit 800, a moving unit 400 that causes the injection unit 300 to advance and retreat with respect to the mold unit 800, a control device 700 that controls each component of the injection molding machine 10, and a frame 900 that supports each component of the injection molding machine 10. The frame 900 includes a mold clamping unit frame 910 that supports the mold clamping unit 100, and an injection unit frame 920 that supports the injection unit 300. The mold clamping unit frame 910 and the injection unit frame 920 are respectively installed on a floor 2 via a leveling adjuster 930. The control device 700 is disposed in an internal space of the injection unit frame 920. Hereinafter, each component of the injection molding machine 10 will be described.

### Mold Clamping Unit

In describing the mold clamping unit 100, a moving direction of a movable platen 120 during mold closing (for example, a positive direction of an X-axis) will be defined as forward, and a moving direction of the movable platen 120 during mold opening (for example, a negative direction of the X-axis) will be defined as rearward.

The mold clamping unit 100 performs mold closing, pressurizing, mold clamping, depressurizing, and mold opening of the mold unit 800. The mold unit 800 includes a stationary mold 810 and a movable mold 820.

For example, the mold clamping unit 100 is of a horizontal type, and the mold opening and closing direction is a horizontal direction. The mold clamping unit 100 includes a stationary platen 110 to which the stationary mold 810 is attached, the movable platen 120 to which the movable mold 820 is attached, and a moving mechanism 102 that moves the movable platen 120 in the mold opening and closing direction with respect to the stationary platen 110.

The stationary platen 110 is fixed to the mold clamping unit frame 910. The stationary mold 810 is attached to a surface of the stationary platen 110 facing the movable platen 120.

The movable platen 120 is disposed to be movable in the mold opening and closing direction with respect to the mold clamping unit frame 910. A guide 101 that guides the movable platen 120 is laid on the mold clamping unit frame 910. The movable mold 820 is attached to a surface of the movable platen 120 facing the stationary platen 110.

The moving mechanism 102 causes the movable platen 120 to advance and retreat with respect to the stationary platen 110 such that mold closing, pressurizing, mold clamping, depressurizing, and mold opening of the mold unit 800 are performed. The moving mechanism 102 includes a toggle support 130 disposed at an interval from the stationary platen 110, a tie bar 140 that connects the stationary platen 110 and the toggle support 130 to each other, a toggle mechanism 150 that moves the movable platen 120 in the mold opening and closing direction with respect to the toggle support 130, a mold clamping motor 160 that operates the toggle mechanism 150, a motion conversion mechanism 170 that converts a rotary motion of the mold clamping motor 160 into a linear motion, and a mold space adjustment mechanism 180 that adjusts an interval between the stationary platen 110 and the toggle support 130.

The toggle support 130 is disposed at an interval from the stationary platen 110, and is placed on the mold clamping unit frame 910 to be movable in the mold opening and closing direction. The toggle support 130 may be disposed to be movable along a guide laid on the mold clamping unit frame 910. The guide of the toggle support 130 may be common to the guide 101 of the movable platen 120.

In the present embodiment, the stationary platen 110 is fixed to the mold clamping unit frame 910, and the toggle support 130 is disposed to be movable in the mold opening and closing direction with respect to the mold clamping unit frame 910. However, the toggle support 130 may be fixed to the mold clamping unit frame 910, and the stationary platen 110 may be disposed to be movable in the mold opening and closing direction with respect to the mold clamping unit frame 910.

The tie bar 140 connects the stationary platen 110 and the toggle support 130 to each other at an interval L in the mold opening and closing direction. A plurality of (for example, four) tie bars 140 may be used. The plurality of tie bars 140 are disposed parallel to each other in the mold opening and closing direction, and extend in accordance with a mold clamping force. At least one of the tie bars 140 may be provided with a tie bar strain detector 141 that measures a strain of the tie bar 140. The tie bar strain detector 141 transmits a signal indicating a measurement result thereof to the control device 700. The measurement result of the tie bar strain detector 141 is used in measuring the mold clamping force.

In the present embodiment, as a mold clamping force detector for measuring the mold clamping force, the tie bar strain detector 141 is used. However, the present invention is not limited thereto. The mold clamping force detector is not limited to a strain gauge type. The mold clamping force detector may be of a piezoelectric type, a capacitive type, a hydraulic oil type, an electromagnetic type, or the like, and an attachment position thereof is not limited to the tie bar 140.

The toggle mechanism 150 is disposed between the movable platen 120 and the toggle support 130, and moves the movable platen 120 in the mold opening and closing direction with respect to the toggle support 130. The toggle mechanism 150 has a crosshead 151 that moves in the mold opening and closing direction, and a pair of link groups bent and stretched by a movement of the crosshead 151. Each of the pair of link groups has a first link 152 and a second link 153 which are connected to be freely bent and stretched by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. When the crosshead 151 is caused to advance and retreat with respect to the toggle support 130, the first link 152 and the second link 153 are bent and stretched, and the movable platen 120 advances and retreats with respect to the toggle support 130.

A configuration of the toggle mechanism 150 is not limited to configurations shown in FIGS. 1 and 2. For example, in FIGS. 1 and 2, the number of nodes in each link group is five, but may be four. One end portion of the third link 154 may be connected to the node between the first link 152 and the second link 153.

The mold clamping motor 160 is attached to the toggle support 130, and operates the toggle mechanism 150. The mold clamping motor 160 causes the crosshead 151 to advance and retreat with respect to the toggle support 130 such that the first link 152 and the second link 153 are bent and stretched, and the movable platen 120 advances and retreats with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotary motion of the mold clamping motor 160 into a linear motion of the crosshead 151. The motion conversion mechanism 170 includes a screw shaft and a screw nut screwed to the screw shaft. A ball or a roller may be interposed between the screw shaft and the screw nut.

The mold clamping unit 100 performs a mold closing process, a pressurizing process, a mold clamping process, a depressurizing process, a mold opening process, and the like under the control of the control device 700.

In the mold closing process, the mold clamping motor 160 is driven to cause the crosshead 151 to advance to a mold closing completion position at a set movement speed, thereby causing the movable platen 120 to advance such that the movable mold 820 touches the stationary mold 810. For example, a position or a movement speed of the crosshead 151 is measured by using a mold clamping motor encoder 161. The mold clamping motor encoder 161 measures rotation of the mold clamping motor 160, and transmits a signal indicating a measurement result thereof to the control device 700.

A crosshead position detector for measuring the position of the crosshead 151 and a crosshead movement speed detector for measuring the movement speed of the crosshead 151 are not limited to the mold clamping motor encoder 161, and a general detector can be used. In addition, a movable platen position detector for measuring a position of the movable platen 120 and a movable platen movement speed detector for measuring a movement speed of the movable platen 120 are not limited to the mold clamping motor encoder 161, and a general detector can be used.

In the pressurizing process, the mold clamping motor 160 is further driven to cause the crosshead 151 to further advance from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (refer to FIG. 2) is formed between the movable mold 820 and the stationary mold 810, and the injection unit 300 fills the cavity space 801 with a liquid molding material. A molding product is obtained by solidifying the molding material filled therein.

The number of the cavity spaces 801 may be one or more. In the latter case, a plurality of the molding products can be obtained at the same time. An insert material may be disposed in a portion of the cavity space 801, and the other portion of the cavity space 801 may be filled with the molding material. A molding product in which the insert material and the molding material are integrated with each other can be obtained.

In the depressurizing process, the mold clamping motor 160 is driven to cause the crosshead 151 to retreat from the mold clamping position to a mold opening start position such that the movable platen 120 retreats to reduce the mold clamping force. The mold opening start position and the mold closing completion position may be the same position.

In the mold opening process, the mold clamping motor 160 is driven to cause the crosshead 151 to retreat from the mold opening start position to a mold opening completion position at a set movement speed such that the movable platen 120 retreats and the movable mold 820 is separated from the stationary mold 810. Thereafter, the ejector unit 200 ejects the molding product from the movable mold 820.

Setting conditions in the mold closing process, the pressurizing process, and the mold clamping process are collectively set as a series of setting conditions. For example, the movement speed, positions (including a mold closing start position, a movement speed switching position, the mold closing completion position, and the mold clamping position), and the mold clamping force of the crosshead 151 in the mold closing process and in the pressurizing process are collectively set as a series of setting conditions. The mold closing start position, the movement speed switching position, the mold closing completion position, and the mold clamping position are aligned in this order from a rear side toward a front side, and represent a start point and an end point of a section in which the movement speed is set. The movement speed is set for each section. The number of the movement speed switching positions may be one or more. The movement speed switching position may not be set. Only one of the mold clamping position and the mold clamping force may be set.

Setting conditions in the depressurizing process and in the mold opening process are set in the same manner. For example, the movement speed or positions (the mold opening start position, the movement speed switching position, and the mold opening completion position) of the crosshead 151 in the depressurizing process and in the mold opening process are collectively set as a series of setting conditions. The mold opening start position, the movement speed switching position, and the mold opening completion position are aligned in this order from the front side toward the rear side, and represent the start point and the end point of the section in which the movement speed is set. The movement speed is set for each section. The number of the movement speed switching positions may be one or more. The movement speed switching position may not be set. The mold opening start position and the mold closing completion position may be the same position. In addition, the mold opening completion position and the mold closing start position may be the same position.

Instead of the movement speed, positions, and the like of the crosshead 151, the movement speed, positions, and the like of the movable platen 120 may be set. In addition, instead of the position (for example, the mold clamping position) of the crosshead or the position of the movable platen, the mold clamping force may be set.

The toggle mechanism 150 amplifies a driving force of the mold clamping motor 160, and transmits the driving force to the movable platen 120. An amplification magnification is referred to as a toggle magnification. The toggle magnification is changed according to an angle θ (hereinafter, also referred to as a “link angle θ”) formed between the first link 152 and the second link 153. The link angle θ is obtained from the position of the crosshead 151. When the link angle θ is 180 °, the toggle magnification is maximized.

In a case where a mold space of the mold unit 800 is changed due to replacement of the mold unit 800, a temperature change in the mold unit 800, or the like, mold space adjustment is performed so that a predetermined mold clamping force is obtained during the mold clamping. For example, in the mold space adjustment, the interval L between the stationary platen 110 and the toggle support 130 is adjusted so that the link angle θ of the toggle mechanism 150 becomes a predetermined angle at a mold touch time at which the movable mold 820 touches the stationary mold 810.

The mold clamping unit 100 has the mold space adjustment mechanism 180. The mold space adjustment mechanism 180 performs the mold space adjustment by adjusting the interval L between the stationary platen 110 and the toggle support 130. For example, a time for the mold space adjustment is performed from an end point of a molding cycle to a start point of a subsequent molding cycle. For example, the mold space adjustment mechanism 180 has a screw shaft 181 formed in a rear end portion of the tie bar 140, a screw nut 182 held by the toggle support 130 to be rotatable and not to advance and retreat, and a mold space adjustment motor 183 that rotates the screw nut 182 screwed to the screw shaft 181.

The screw shaft 181 and the screw nut 182 are provided for each of the tie bars 140. A rotational driving force of the mold space adjustment motor 183 may be transmitted to a plurality of the screw nuts 182 via a rotational driving force transmitting unit 185. The plurality of screw nuts 182 can be rotated in synchronization with each other. The plurality of screw nuts 182 can be individually rotated by changing a transmission channel of the rotational driving force transmitting unit 185.

For example, the rotational driving force transmitting unit 185 is configured to include a gear. In this case, a driven gear is formed on an outer periphery of each screw nut 182, a driving gear is attached to an output shaft of the mold space adjustment motor 183, and an intermediate gear meshing with a plurality of the driven gears and the driving gear are held to be rotatable in a central portion of the toggle support 130. The rotational driving force transmitting unit 185 may be configured to include a belt, a pulley, or the like instead of the gear.

An operation of the mold space adjustment mechanism 180 is controlled by the control device 700. The control device 700 drives the mold space adjustment motor 183 to rotate the screw nut 182. As a result, a position of the toggle support 130 with respect to the tie bar 140 is adjusted, and the interval L between the stationary platen 110 and the toggle support 130 is adjusted. In addition, a plurality of the mold space adjustment mechanisms may be used in combination.

The interval L is measured by using a mold space adjustment motor encoder 184. The mold space adjustment motor encoder 184 measures a rotation amount or a rotation direction of the mold space adjustment motor 183, and transmits a signal indicating a measurement result thereof to the control device 700. The measurement result of the mold space adjustment motor encoder 184 is used in monitoring or controlling the position or the interval L of the toggle support 130. A toggle support position detector for measuring the position of the toggle support 130 and an interval detector for measuring the interval L are not limited to the mold space adjustment motor encoder 184, and a general detector can be used.

The mold clamping unit 100 may include a mold temperature controller that adjusts a temperature of the mold unit 800. The mold unit 800 internally has a flow path of a temperature control medium. The mold temperature controller adjusts the temperature of the mold unit 800 by adjusting a temperature of the temperature control medium supplied to the flow path of the mold unit 800.

The mold clamping unit 100 of the present embodiment is of the horizontal type in which the mold opening and closing direction is the horizontal direction, but may be of a vertical type in which the mold opening and closing direction is an upward-downward direction.

The mold clamping unit 100 of the present embodiment has the mold clamping motor 160 as a drive unit. However, a hydraulic oil cylinder may be provided instead of the mold clamping motor 160. In addition, the mold clamping unit 100 may have a linear motor for mold opening and closing, and may have an electromagnet for mold clamping. Ejector Unit

In describing the ejector unit 200, similarly to the description of the mold clamping unit 100, a moving direction of the movable platen 120 during the mold closing (for example, the positive direction of the X-axis) will be defined as forward, and a moving direction of the movable platen 120 during the mold opening (for example, the negative direction of the X-axis) will be defined as rearward.

The ejector unit 200 is attached to the movable platen 120, and advances and retreats together with the movable platen 120. The ejector unit 200 has an ejector rod 210 that ejects a molding product from the mold unit 800, and a drive mechanism 220 that moves the ejector rod 210 in the moving direction (X-axis direction) of the movable platen 120.

The ejector rod 210 is disposed to be able to advance and retreat in a through-hole of the movable platen 120. A front end portion of the ejector rod 210 comes into contact with an ejector plate 826 of the movable mold 820. The front end portion of the ejector rod 210 may be connected to or may not be connected to the ejector plate 826.

For example, the drive mechanism 220 has an ejector motor and a motion conversion mechanism that converts a rotary motion of the ejector motor into a linear motion of the ejector rod 210. The motion conversion mechanism includes a screw shaft and a screw nut screwed to the screw shaft. A ball or a roller may be interposed between the screw shaft and the screw nut.

The ejector unit 200 performs an ejection process under the control of the control device 700. In the ejection process, the ejector rod 210 is caused to advance from a standby position to an ejection position at a set movement speed such that the ejector plate 826 advances to eject the molding product. Thereafter, the ejector motor is driven to cause the ejector rod 210 to retreat at a set movement speed such that the ejector plate 826 retreats to an original standby position.

For example, a position or a movement speed of the ejector rod 210 is measured by using an ejector motor encoder. The ejector motor encoder measures the rotation of the ejector motor, and transmits a signal indicating a measurement result thereof to the control device 700. An ejector rod position detector for measuring the position of the ejector rod 210, and an ejector rod movement speed detector for measuring the movement speed of the ejector rod 210 are not limited to the ejector motor encoder, and a general detector can be used.

### Injection Unit

In describing the injection unit 300, unlike the description of the mold clamping unit 100 or the description of the ejector unit 200, a moving direction of a screw 330 during filling (for example, the negative direction of the X-axis) will be defined as forward, and a moving direction of the screw 330 during plasticizing (for example, the positive direction of the X-axis) will be defined as rearward.

The injection unit 300 is installed on a slide base 301, and the slide base 301 is disposed to be able to advance and retreat with respect to the injection unit frame 920. The injection unit 300 is disposed to be able to advance and retreat with respect to the mold unit 800. The injection unit 300 touches the mold unit 800, and fills the cavity space 801 inside the mold unit 800 with the molding material. For example, the injection unit 300 has a cylinder 310 that heats the molding material, a nozzle 320 provided in a front end portion of the cylinder 310, the screw 330 disposed to be able to advance and retreat and to rotate inside the cylinder 310, a plasticizing motor 340 that rotates the screw 330, an injection motor 350 that causes the screw 330 to advance and retreat, and a load detector 360 that measures a load transmitted between the injection motor 350 and the screw 330.

The cylinder 310 heats the molding material supplied into the cylinder 310 from a feed port 311. For example, the molding material includes a resin. For example, the molding material is formed in a pellet shape, and is supplied to the feed port 311 in a solid state. The feed port 311 is formed in a rear portion of the cylinder 310. A cooler 312 such as a water-cooling cylinder is provided on an outer periphery of the rear portion of the cylinder 310. In front of the cooler 312, a first heating unit 313 such as a band heater and a first temperature measurer 314 are provided on an outer periphery of the cylinder 310.

The cylinder 310 is divided into a plurality of zones in an axial direction (for example, the X-axis direction) of the cylinder 310. The first heating unit 313 and the first temperature measurer 314 are provided in each of the plurality of zones. The control device 700 controls the first heating unit 313 so that a set temperature is set in each of the plurality of zones and a measurement temperature of the first temperature measurer 314 reaches the set temperature.

The nozzle 320 is provided in the front end portion of the cylinder 310, and is pressed against the mold unit 800. A second heating unit 323 and a second temperature measurer 324 are provided on an outer periphery of the nozzle 320. The control device 700 controls the second heating unit 323 so that a measurement temperature of the nozzle 320 reaches the set temperature.

The screw 330 is disposed to be able to rotate and to advance and retreat inside the cylinder 310. When the screw 330 is rotated, the molding material is fed forward along a helical groove of the screw 330. The molding material is gradually melted by heat from the cylinder 310 while being fed forward. As the liquid molding material is fed forward of the screw 330 and is accumulated in a front portion of the cylinder 310, the screw 330 retreats. Thereafter, when the screw 330 is caused to advance, the liquid molding material accumulated in front of the screw 330 is injected from the nozzle 320, and fills an inside of the mold unit 800.

As a backflow prevention valve for preventing a backflow of the molding material fed rearward from the front of the screw 330 when the screw 330 is pressed forward, a backflow prevention ring 331 is attached to a front portion of the screw 330 to be able to advance and retreat.

The backflow prevention ring 331 is pressed rearward by a pressure of the molding material in front of the screw 330 when the screw 330 is caused to advance, and retreats relative to the screw 330 to a close position (refer to FIG. 2) at which a flow path of the molding material is closed. Accordingly, the molding material accumulated in front of the screw 330 is prevented from flowing rearward.

On the other hand, the backflow prevention ring 331 is pressed forward by the pressure of the molding material fed forward along the helical groove of the screw 330 when the screw 330 is rotated, and advances relative to the screw 330 to an open position (refer to FIG. 1) at which the flow path of the molding material is open. Accordingly, the molding material is fed forward of the screw 330.

The backflow prevention ring 331 may be of either a co-rotation type rotating together with the screw 330 or a non-co-rotation type that does not rotate together with the screw 330.

The injection unit 300 may have a drive source that causes the backflow prevention ring 331 to advance and retreat with respect to the screw 330 between the open position and the close position.

The plasticizing motor 340 rotates the screw 330. A drive source that rotates the screw 330 is not limited to the plasticizing motor 340, and may be a hydraulic oil pump, for example.

The injection motor 350 causes the screw 330 to advance and retreat. A motion conversion mechanism that converts a rotary motion of the injection motor 350 into a linear motion of the screw 330 or the like is provided between the injection motor 350 and the screw 330. For example, the motion conversion mechanism has a screw shaft and a screw nut screwed to the screw shaft. A ball or a roller may be provided between the screw shaft and the screw nut. A drive source that causes the screw 330 to advance and retreat is not limited to the injection motor 350, and may be a hydraulic oil cylinder, for example.

The load detector 360 measures a load transmitted between the injection motor 350 and the screw 330. The measured load is converted into a pressure by the control device 700. The load detector 360 is provided in a load transmission channel between the injection motor 350 and the screw 330, and measures the load acting on the load detector 360.

The load detector 360 transmits a signal of the measured load to the control device 700. The load measured by the load detector 360 is converted into the pressure acting between the screw 330 and the molding material, and is used in controlling or monitoring the pressure received from the molding material by the screw 330, a back pressure against the screw 330, the pressure acting on the molding material from the screw 330, or the like.

A pressure detector for measuring the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed inside the mold unit 800.

The injection unit 300 performs a plasticizing process, a filling process, a pressure holding process, and the like under the control of the control device 700. The filling process and the pressure holding process may be collectively referred to as an injection process.

In the plasticizing process, the plasticizing motor 340 is driven to rotate the screw 330 at a set rotational speed such that the molding material is fed forward along the helical groove of the screw 330. As a result, the molding material is gradually melted. As the liquid molding material is fed forward of the screw 330 and is accumulated in a front portion of the cylinder 310, the screw 330 retreats. For example, the rotational speed of the screw 330 is measured by using a plasticizing motor encoder 341. The plasticizing motor encoder 341 measures the rotation of the plasticizing motor 340, and transmits a signal indicating a measurement result thereof to the control device 700. A screw rotational speed detector for measuring the rotational speed of the screw 330 is not limited to the plasticizing motor encoder 341, and a general detector can be used.

In the plasticizing process, the injection motor 350 may be driven to apply a set back pressure to the screw 330 in order to limit a sudden retreat of the screw 330. The back pressure applied to the screw 330 is measured by using the load detector 360, for example. When the screw 330 retreats to a plasticizing completion position and a predetermined amount of the molding material is accumulated in front of the screw 330, the plasticizing process is completed.

The position and the rotational speed of the screw 330 in the plasticizing process are collectively set as a series of setting conditions. For example, a plasticizing start position, a rotational speed switching position, and the plasticizing completion position are set. These positions are aligned in this order from the front side toward the rear side, and represent a start point and an end point of a section in which the rotational speed is set. The rotational speed is set for each section. The number of the rotational speed switching positions may be one or more. The rotational speed switching position may not be set. In addition, the back pressure is set for each section.

In the filling process, the injection motor 350 is driven to cause the screw 330 to advance at a set movement speed, and the cavity space 801 inside the mold unit 800 is filled with the liquid molding material accumulated in front of the screw 330. The position or the movement speed of the screw 330 is measured by using an injection motor encoder 351, for example. The injection motor encoder 351 measures the rotation of the injection motor 350, and transmits a signal indicating a measurement result thereof to the control device 700. When the position of the screw 330 reaches a set position, the filling process is switched to the pressure holding process (so-called V/P switching). The position where the V/P switching is performed will be referred to as a V/P switching position. The set movement speed of the screw 330 may be changed in accordance with the position, a time, or the like of the screw 330.

The position and the movement speed of the screw 330 in the filling process are collectively set as a series of setting conditions. For example, a filling start position (also referred to as an “injection start position”), the movement speed switching position, and the V/P switching position are set. These positions are aligned in this order from the rear side toward the front side, and represent the start point and the end point of the section in which the movement speed is set. The movement speed is set for each section. The number of the movement speed switching positions may be one or more. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a set pressure, the screw 330 advances at a set movement speed. On the other hand, in a case where the pressure of the screw 330 exceeds the set pressure, in order to protect the mold, the screw 330 is caused to advance at a movement speed slower than the set movement speed so that the pressure of the screw 330 is equal to or lower than the set pressure.

After the position of the screw 330 reaches the V/P switching position in the filling process, the screw 330 may be temporarily stopped at the V/P switching position, and thereafter, the V/P switching may be performed. Immediately before the V/P switching, instead of the screw 330 being stopped, the screw 330 may be caused to advance at a low speed, or may be caused to retreat at a low speed. In addition, a screw position detector for measuring the position of the screw 330 and a screw movement speed detector for measuring the movement speed of the screw 330 are not limited to the injection motor encoder 351, and a general detector can be used.

In the pressure holding process, the injection motor 350 is driven to press the screw 330 forward. A pressure (hereinafter, also referred to as a “holding pressure”) of the molding material in a front end portion of the screw 330 is held at a set pressure, and the molding material remaining inside the cylinder 310 is pressed toward the mold unit 800. An insufficient amount of the molding material due to cooling shrinkage inside the mold unit 800 can be replenished. The holding pressure is measured by using the load detector 360, for example. A set value of the holding pressure may be changed depending on an elapsed time from the start of the pressure holding process or the like. A plurality of holding pressures and a plurality of holding times for holding the holding pressures in the pressure holding process may be respectively set, or may be collectively set as a series of setting conditions.

In the pressure holding process, the molding material in the cavity space 801 inside the mold unit 800 is gradually cooled, and when the pressure holding process is completed, an inlet of the cavity space 801 is closed by the solidified molding material. This state is referred to as gate seal, and prevents the backflow of the molding material from the cavity space 801. After the pressure holding process, a cooling process starts. In the cooling process, the molding material inside the cavity space 801 is solidified. In order to shorten a molding cycle time, the plasticizing process may be performed during the cooling process.

The injection unit 300 of the present embodiment is of an in-line screw type, but may be of a pre-plasticizing type. The pre-plasticizing type injection unit supplies the molding material melted inside a plasticizing cylinder to an injection cylinder, and the molding material is injected into the mold unit from the injection cylinder. Inside the plasticizing cylinder, the screw is disposed to be rotatable and not to advance and retreat, or the screw is disposed to be rotatable and to be able to advance and retreat. Meanwhile, a plunger is disposed to be able to advance and retreat inside the injection cylinder.

In addition, the injection unit 300 of the present embodiment is of a horizontal type in which the axial direction of the cylinder 310 is a horizontal direction, but may be of a vertical type in which the axial direction of the cylinder 310 is an upward-downward direction. The mold clamping unit combined with a vertical type injection unit 300 may be of the vertical type or the horizontal type. Similarly, the mold clamping unit combined with a horizontal type injection unit 300 may be of the horizontal type or the vertical type.

### Moving Unit

In describing the moving unit 400, similarly to the description of the injection unit 300, a moving direction of the screw 330 during the filling (for example, the negative direction of the X-axis) will be defined as forward, and a moving direction of the screw 330 during the plasticizing (for example, the positive direction of the X-axis) will be defined as rearward.

The moving unit 400 causes the injection unit 300 to advance and retreat with respect to the mold unit 800. The moving unit 400 presses the nozzle 320 against the mold unit 800, thereby generating a nozzle touch pressure. The moving unit 400 includes a hydraulic pump 410, a motor 420 serving as a drive source, a hydraulic cylinder 430 serving as a hydraulic actuator, and the like.

The hydraulic pump 410 has a first port 411 and a second port 412. The hydraulic pump 410 is a pump that can rotate in both directions, and switches rotation directions of the motor 420 such that a hydraulic fluid (for example, oil) is suctioned from any one of the first port 411 and the second port 412 and is discharged from the other to generate a hydraulic pressure. The hydraulic pump 410 can suction the hydraulic fluid from a tank, and can discharge the hydraulic fluid from any one of the first port 411 and the second port 412.

The motor 420 operates the hydraulic pump 410. The motor 420 drives the hydraulic pump 410 in a rotation direction and with a rotation torque in accordance with a control signal transmitted from the control device 700. The motor 420 may be an electric motor, or may be an electric servo motor.

The hydraulic cylinder 430 has a cylinder body 431, a piston 432, and a piston rod 433. The cylinder body 431 is fixed to the injection unit 300. The piston 432 partitions an inside of the cylinder body 431 into a front chamber 435 serving as a first chamber and into a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow path 401. The hydraulic fluid discharged from the first port 411 is supplied to the front chamber 435 via the first flow path 401, whereby the injection unit 300 is pressed forward. The injection unit 300 advances, and the nozzle 320 is pressed against the stationary mold 810. The front chamber 435 functions as a pressure chamber that generates the nozzle touch pressure of the nozzle 320 by means of the pressure of the hydraulic fluid supplied from the hydraulic pump 410.

On the other hand, the rear chamber 436 of the hydraulic cylinder 430 is connected to the second port 412 of the hydraulic pump 410 via a second flow path 402. The hydraulic fluid discharged from the second port 412 is supplied to the rear chamber 436 of the hydraulic cylinder 430 via the second flow path 402, whereby the injection unit 300 is pressed rearward. The injection unit 300 retreats, and the nozzle 320 is separated from the stationary mold 810.

In the present embodiment, the moving unit 400 includes the hydraulic cylinder 430, but the present invention is not limited thereto. For example, instead of the hydraulic cylinder 430, an electric motor and a motion conversion mechanism that converts a rotary motion of the electric motor into a linear motion of the injection unit 300 may be used.

### Control Device

For example, the control device 700 is configured to include a computer, and has a central processing unit (CPU) 701, a storage medium 702 such as a memory, an input interface 703, and an output interface 704 as shown in FIGS. 1 and 2. The control device 700 performs various types of control by causing the CPU 701 to execute a program stored in the storage medium 702. In addition, the control device 700 receives a signal from the outside through the input interface 703, and transmits the signal to the outside through the output interface 704.

The control device 700 repeatedly performs the plasticizing process, the mold closing process, the pressurizing process, the mold clamping process, the filling process, the pressure holding process, the cooling process, the depressurizing process, the mold opening process, the ejection process, and the like, thereby repeatedly manufacturing the molding product. A series of operations for obtaining the molding product, for example, an operation from the start of the plasticizing process to the start of the subsequent plasticizing process, will be referred to as a “shot” or a “molding cycle”. In addition, a time required for one shot will be referred to as a “molding cycle time” or a “cycle time”.

For example, one molding cycle has the plasticizing process, the mold closing process, the pressurizing process, the mold clamping process, the filling process, the pressure holding process, the cooling process, the depressurizing process, the mold opening process, and the ejection process in this order. The order described here is the order of the start times of the respective processes. The filling process, the pressure holding process, and the cooling process are performed during the mold clamping process. The start of the mold clamping process may coincide with the start of the filling process. The completion of the depressurizing process coincides with the start of the mold opening process.

A plurality of processes may be performed at the same time in order to shorten the molding cycle time. For example, the plasticizing process may be performed during the cooling process of the previous molding cycle or may be performed during the mold clamping process. In this case, the mold closing process may be performed in an initial stage of the molding cycle. In addition, the filling process may start during the mold closing process. In addition, the ejection process may start during the mold opening process. In a case where an on-off valve for opening and closing a flow path of the nozzle 320 is provided, the mold opening process may start during the plasticizing process. The reason is as follows. Even in a case where the mold opening process starts during the plasticizing process, when the on-off valve closes the flow path of the nozzle 320, the molding material does not leak from the nozzle 320.

One molding cycle may include a process other than the plasticizing process, the mold closing process, the pressurizing process, the mold clamping process, the filling process, the pressure holding process, the cooling process, the depressurizing process, the mold opening process, and the ejection process.

For example, after the pressure holding process is completed and before the plasticizing process starts, a pre-plasticizing suck-back process of causing the screw 330 to retreat to a preset plasticizing start position may be performed. The pressure of the molding material accumulated in front of the screw 330 before the plasticizing process starts can be reduced, and a sudden retreat of the screw 330 when the plasticizing process starts can be prevented.

In addition, after the plasticizing process is completed and before the filling process starts, a post-plasticizing suck-back process may be performed in which the screw 330 is caused to retreat to a preset filling start position (also referred to as an “injection start position”). The pressure of the molding material accumulated in front of the screw 330 before the filling process starts can be reduced, and a leakage of the molding material from the nozzle 320 before the filling process starts can be prevented.

The control device 700 is connected to an operation device 750 that receives an input operation of a user, and to a display device 760 that displays a screen. For example, the operation device 750 and the display device 760 may be integrated with each other in a form of a touch panel 770. The touch panel 770 serving as the display device 760 displays the screen under the control of the control device 700. For example, the screen of the touch panel 770 may display settings of the injection molding machine 10, and information on a current state of the injection molding machine 10. In addition, for example, the screen of the touch panel 770 may display a button for accepting the input operation of the user or an operation portion such as an input field. The touch panel 770 serving as the operation device 750 detects an input operation of the user on the screen, and outputs a signal corresponding to the input operation to the control device 700. In this manner, for example, while checking information displayed on the screen, the user can perform setting (including an input of a set value) of the injection molding machine 10 by operating the operation portion provided on the screen. In addition, the user can operate the injection molding machine 10 corresponding to the operation portion by operating the operation portion provided on the screen. For example, the operation of the injection molding machine 10 may be an operation (including stopping) of the mold clamping unit 100, the ejector unit 200, the injection unit 300, the moving unit 400, or the like. In addition, the operation of the injection molding machine 10 may be switching between the screens displayed on the touch panel 770 serving as the display device 760.

A case has been described in which the operation device 750 and the display device 760 of the present embodiment are integrated with each other as the touch panel 770. However, both the operation device 750 and the display device 760 may be independently provided. In addition, a plurality of the operation devices 750 may be provided. The operation device 750 and the display device 760 are disposed on the operation side (a negative direction of the Y-axis) of the mold clamping unit 100 (more specifically, the stationary platen 110).

### Details of Control Device

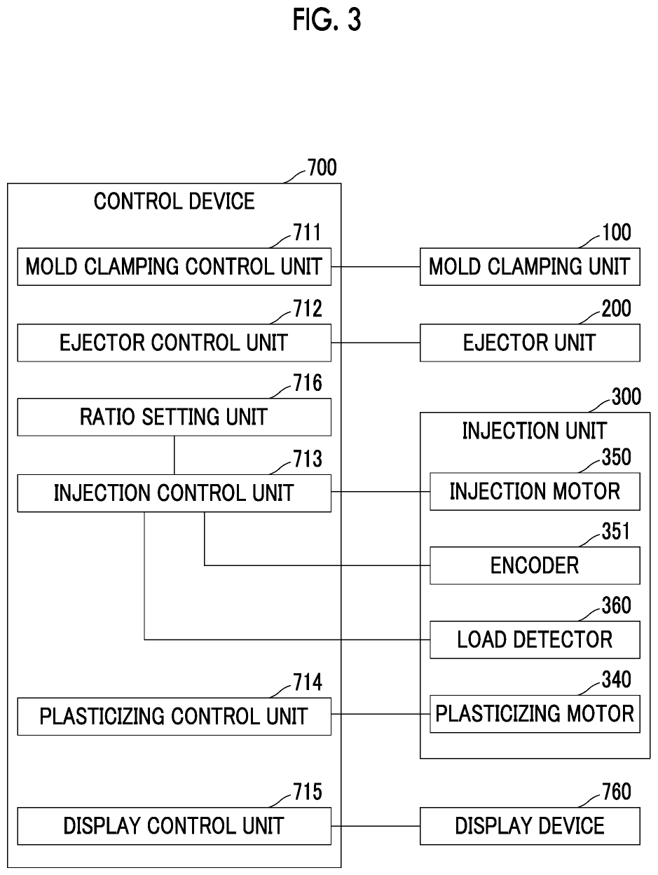

Next, an example of components of the control device 700 will be described with reference to FIG. 3. Each functional block shown in FIG. 3 is conceptual, and may not necessarily be configured to be physical as shown. All or a portion of each functional block can be configured to be functionally or physically distributed and integrated in any desired unit. All or any desired portion of each processing function performed in each functional block may be realized by a program executed by a CPU, or may be realized as hardware using a wired logic.

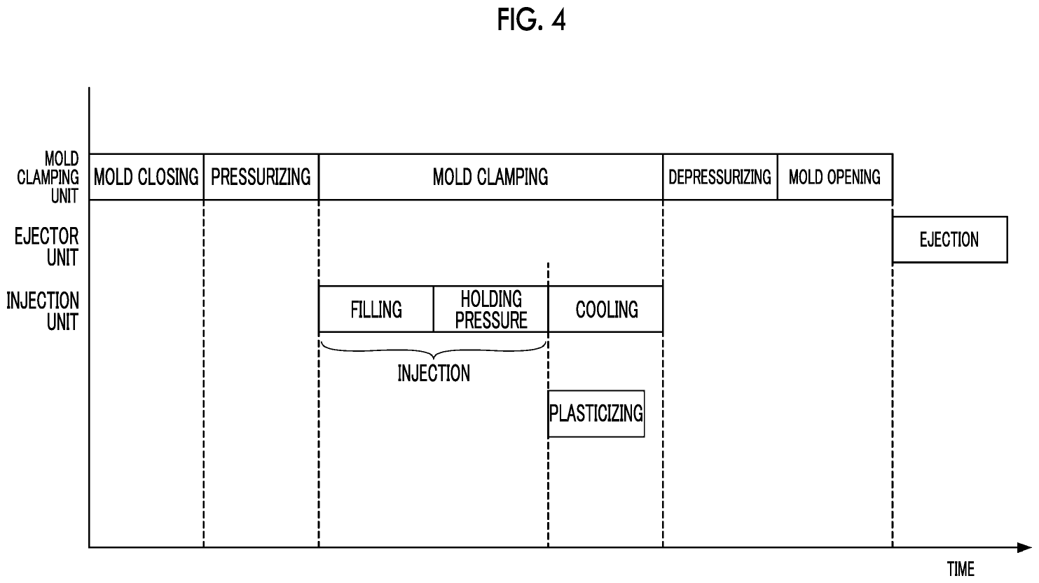

As shown in FIG. 3, for example, the control device 700 includes a mold clamping control unit 711, an ejector control unit 712, an injection control unit 713, a plasticizing control unit 714, a display control unit 715, and a ratio setting unit 716. The mold clamping control unit 711 controls the mold clamping unit 100 to perform the mold closing process, the pressurizing process, the mold clamping process, the depressurizing process, and the mold opening process shown in FIG. 4. The ejector control unit 712 controls the ejector unit 200 to perform the ejection process. The injection control unit 713 controls an injection drive source of the injection unit 300 to perform the injection process. The injection drive source is, for example, the injection motor 350, but may be a hydraulic oil cylinder or the like. The injection process includes the filling process and the pressure holding process. The injection process is performed during the mold clamping process. The plasticizing control unit 714 controls a plasticizing drive source of the injection unit 300 to perform the plasticizing process. The plasticizing drive source is, for example, the plasticizing motor 340, but may be a hydraulic oil pump or the like. The plasticizing process is performed during the cooling process. The display control unit 715 controls the display device 760.

The filling process is a process of controlling the injection drive source so that an actual value of a movement speed of an injection member provided inside the cylinder 310 becomes a set value. The filling process is a process of filling the inside of the mold unit 800 with the liquid molding material (for example, a resin) accumulated in front of the injection member by moving the injection member forward. The injection member is, for example, the screw 330, but may be a plunger.

The movement speed of the injection member is measured by using a speed detector. The speed detector is, for example, the injection motor encoder 351. In the filling process, the pressure acting on the molding material from the injection member increases as the injection member moves forward. The filling process may include a process of temporarily stopping the injection member or a process of causing the injection member to retreat immediately before the pressure holding process.

The pressure holding process is a process of controlling the injection drive source so that an actual value of the pressure acting on the molding material from the injection member becomes a set value. The pressure holding process is a process of replenishing a shortage of the molding material due to cooling shrinkage in the mold unit 800 by pressing the injection member forward. The pressure is measured by using a pressure detector such as the load detector 360. As the pressure detector, the nozzle pressure sensor or the mold internal pressure sensor may be used.

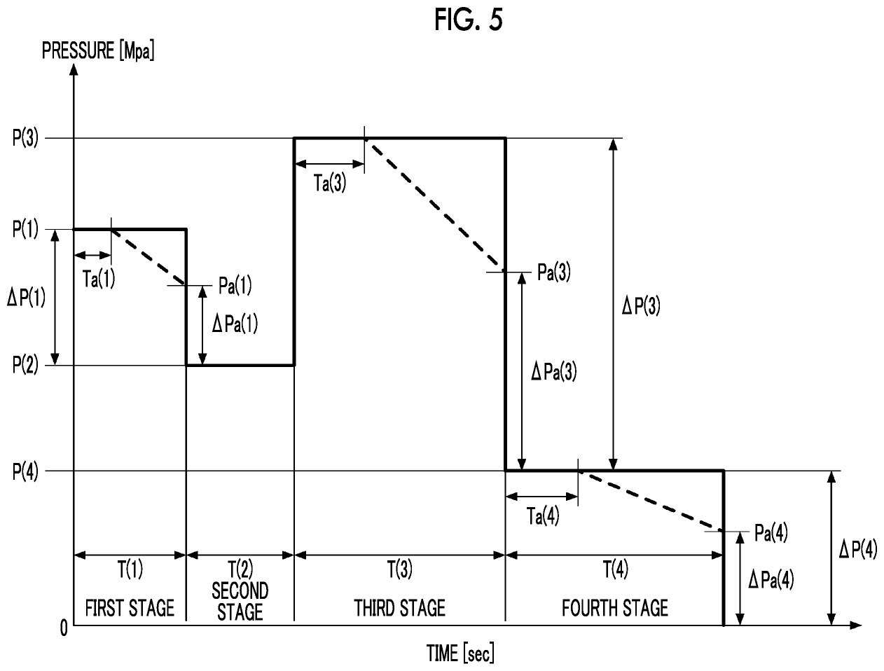

Next, an example of a change in the set value of the pressure and in the actual value of the pressure in the pressure holding process will be described with reference to FIG. 5. In FIG. 5, a thick solid line indicates a change in the set value of the pressure over time. The injection control unit 713 essentially causes the actual value of the pressure to coincide with the set value of the pressure, but may gradually decrease the actual value of the pressure relative to the set value of the pressure as indicated by a thick dashed line in order to reduce power consumption of the injection motor 350.

As shown in FIG. 5, the pressure holding process has n stages (n is an integer of 1 or more) of combinations of set values of the pressure and holding times for holding the set values. In FIG. 5, n is 4, but may be 1 or may be 2 to 3 or 5 or more. For each stage, set values P(1) to P(4) of the pressure and set values T(1) to T(4) of the holding time are set. These settings are performed by the user using an input device such as the touch panel 770.

The injection control unit 713 essentially performs feedback-control on the injection motor 350 so that a pressure actual value becomes a pressure set value at each stage. In addition, the injection control unit 713 performs pressure reduction control to gradually reduce the pressure actual value with respect to the pressure set value from the middle of a k-th stage (k is an integer of 1 or more and n or less) to the end of the k-th stage.

As will be described in detail later, the injection control unit 713 may not perform the pressure reduction control from the middle of the k-th stage to the end of the k-th stage. For example, when the pressure actual value reaches a lower limit before the end of the k-th stage by means of the pressure reduction control, the injection control unit 713 may perform pressure holding control to keep the pressure actual value constant at the lower limit from that point to the end of the k-th stage.

The pressure reduction control may be performed in at least one stage. The pressure reduction control is preferably performed at a stage at which the pressure set value is highest, and the k-th stage is preferably a stage at which the pressure set value is highest. This is because it is effective in reducing the power consumption to perform the pressure reduction control at the stage at which the set value of the pressure is highest.

In FIG. 5, the stage at which the pressure set value is highest is a third stage (k=3). As shown in FIG. 5, the pressure reduction control may also be performed at a stage other than the stage at which the pressure set value is highest (for example, the third stage). In FIG. 5, the pressure reduction control is performed in a first stage, the third stage, and a fourth stage. As will be described in detail later, the pressure reduction control is not performed in a second stage.

As cooling solidification of the molding material (for example, the resin) progresses, the pressure required to prevent the backflow of the molding material gradually decreases. Therefore, generating a constant pressure from the start to the end of the k-th stage causes an excessive pressure to be generated from the middle of the k-th stage, which is a waste of power. When the pressure is reduced over time from the middle of the k-th stage, the power consumption can be reduced.

In the pressure reduction control, the feedback-control of the injection motor 350 is performed by using a value subtracted from the pressure set value over time instead of the pressure set value. Alternatively, in the pressure reduction control, the feedback-control of the injection motor 350 is performed by using a value added to the pressure actual value over time instead of the pressure actual value.

The injection control unit 713 may perform the feedback-control on the injection motor 350 so that a current actual value or a torque actual value of the injection motor 350 becomes a current command value or a torque command value in the pressure holding process.

In this case, in the pressure reduction control, the feedback-control of the injection motor 350 is performed using a value subtracted from the current command value or from the torque command value over time, instead of the current command value or the torque command value. Alternatively, in the pressure reduction control, the feedback-control of the injection motor 350 is performed using a value added to the current actual value or to the torque actual value over time, instead of the current actual value or the torque actual value.

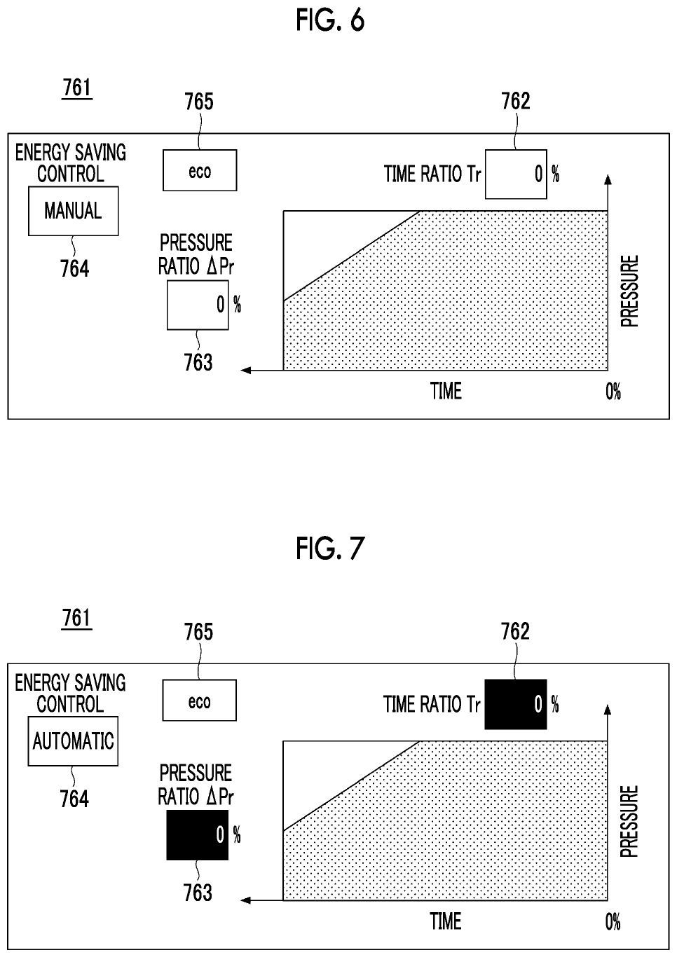

Next, an example of a screen 761 for manually setting a time ratio Tr(k) and a pressure ratio ΔPr(k) will be described with reference to FIG. 6. The screen 761 is displayed on the display device 760 by the display control unit 715. For example, the screen 761 has a first input field 762 and a second input field 763. The first input field 762 is a field for inputting the time ratio Tr(k). The second input field 763 is a field for inputting the pressure ratio ΔPr(k). Tr(k) is a ratio of a start time Ta(k) at which the pressure reduction control starts in the k-th stage to a set value T(k) of the holding time in the k-th stage. Tr(k) is calculated from Equation (1) when expressed as a percentage.

Tr(k)=Ta(k)/T(k)×100 (1)

ΔPr(k) is a ratio of a difference ΔPa(k) between an actual value Pa(k) of the pressure at the end of the k-th stage and a reference value Pt(k) to a difference ΔP(k) between a set value P(k) of the pressure in the k-th stage and the reference value Pt(k). ΔPr(k) is calculated from Equation (2) when expressed as a percentage.

ΔPr(k)=ΔPa(k)/ΔP(k)×100 (2)

Here, the reference value Pt(k) of the pressure in the k-th stage is a set value P(n+1) of the pressure in a (k+1)-th stage in a case where k is (n−1) or less, and is 0 MPa in a case where k is n. Pt(k) is 0 MPa in a case where k is n because when the pressure holding process is ended, the power supply to the injection motor 350 is stopped and the pressure becomes 0 MPa.

For example, the screen 761 is a screen common to all stages. The same values are used for the time ratio and the pressure ratio in all stages. Therefore, a calculation load can be reduced. The screen 761 may be prepared for each stage, and different values may be used for the time ratio and the pressure ratio in a plurality of stages. In this case, while the calculation load increases, it is easier to maintain quality of a molding product.

The screen 761 has a switching button 764. The switching button 764 is, for example, in a pull-down format, and accepts an input of one candidate selected by the user from a plurality of candidates registered in advance. In addition, the switching button 764 displays the candidate selected by the user on the screen 761. The candidate to be displayed is not particularly limited, and examples thereof include “MANUAL” and “OFF”.

When a predetermined input operation (hereinafter, also referred to as a first input operation) is performed with the switching button 764, the injection control unit 713 performs the pressure reduction control according to the time ratio Tr(k) and the pressure ratio ΔPr(k) input to the screen 761. In this case, the switching button 764 displays, for example, “MANUAL” as shown in FIG. 6 under the control of the display control unit 715, and informs the user of the current setting in text.

On the other hand, when a second input operation different from the first input operation is performed with the switching button 764, the injection control unit 713 does not perform the pressure reduction control. In this case, the switching button 764 displays “OFF” under the control of the display control unit 715, and informs the user of the current setting in text.

In order to perform the pressure reduction control, it is necessary to determine the time ratio Tr(k) and the pressure ratio ΔPr(k). In a case where the time ratio Tr(k) and the pressure ratio ΔPr(k) are inappropriate, the quality of the molding product decreases. It is necessary to determine the time ratio Tr(k) and the pressure ratio ΔPr(k) so that the quality of the molding product can be maintained, which imposes a heavy burden on the user.

Therefore, the control device 700 of the present embodiment includes the ratio setting unit 716 as shown in FIG. 3. The ratio setting unit 716 sets the time ratio Tr(k) in the k-th stage and the pressure ratio ΔPr(k) in the k-th stage based on the set value P(k) of the pressure in the k-th stage, the set value T(k) of the holding time in the k-th stage, and information stored in advance. Parameters used for the pressure reduction control can be automatically set, and a burden on the user can be reduced.

Examples of the information stored in advance include the start time Ta(k) at which the pressure reduction control starts in the k-th stage and a reduction rate V(k) of the pressure in the k-th stage. Here, the k-th stage is not particularly limited, but as described above, for example, the k-th stage is the stage at which the set value of the pressure is highest. This is because it is effective in reducing the power consumption to perform the pressure reduction control at the stage at which the set value of the pressure is highest.

The earlier the start time Ta(k) is, the smaller the power consumption is. However, when the start time Ta(k) is too early, the pressure reduction control may start before the actual value of the pressure in the entire cavity space 801 reaches a target P(k). This is because the cavity space 801 is distant from the injection motor 350, so it takes time to transmit the pressure.

The start time Ta(k) is determined in consideration of a time difference ΔT from the start of the k-th stage until the actual value of the pressure reaches the target P(k) in the entire cavity space 801. The start time Ta(k) may be the time difference ΔT, or may be a value obtained by multiplying the time difference ΔT by a safety coefficient. The start time Ta(k) is not particularly limited, but is, for example, 1 second.

The start time Ta(k) may be determined by using the mold internal pressure sensor. The mold internal pressure sensor is installed inside the mold unit 800. It is also possible to use the nozzle pressure sensor or the load detector 360 instead of the mold internal pressure sensor. In addition, it is also possible to use a current sensor instead of the mold internal pressure sensor. The current sensor detects a supply current to the injection motor 350. The larger the supply current is, the larger the torque is and the higher the pressure is.

The faster the reduction rate V(k) is, the smaller the power consumption is. However, when the reduction rate V(k) is too fast, a backflow of the molding material or insufficient replenishment of the molding material may occur. The reduction rate V(k) is determined in advance by an experiment or the like. For example, a molding product is manufactured by varying the reduction rate V(k), and a weight or dimensions of the molding product are measured to determine the reduction rate V(k). It is preferable to conduct an experiment on molding products having different target shapes or different target dimensions and to determine the reduction rate V(k) so that good products are obtained for all the molding products. The reduction rate V(k) is not particularly limited, but is, for example, 1 MPa/sec.

For example, the ratio setting unit 716 calculates the time ratio Tr(k) and the pressure ratio ΔPr(k) by using Equations (1) and (2). The ratio setting unit 716 calculates the pressure ratio Pr(k) by substituting Pa(k) calculated using Equation (3) below into Equation (2).

Pa(k)=P(k)−V(k)×(T(k)−Ta(k)) (3)

The ratio setting unit 716 may use the same value as the time ratio Tr(k) in the k-th stage as a time ratio Tr(m) in an m-th stage (m is an integer of 1 or more and n or less and is different from k), and may use the same value as the pressure ratio ΔPr(k) in the k-th stage as a pressure ratio ΔPr(m) in the m-th stage. The same values are used for the time ratio and the pressure ratio in all stages. Therefore, a calculation load can be reduced.

The ratio setting unit 716 may calculate the time ratio and the pressure ratio for each stage. In this case, while the calculation load increases, it is easier to maintain the quality of the molding product. In this case, the ratio setting unit 716 calculates the pressure ratio ΔPr(m) and the time ratio Tr(m) in the m-th stage in the same manner as the pressure ratio ΔPr(k) and the time ratio Tr(k) in the k-th stage. That is, the ratio setting unit 716 may set the time ratio Tr(m) in the m-th stage and the pressure ratio ΔPr(m) in the m-th stage based on a set value P(m) of the pressure in the m-th stage, a set value T(m) of the holding time in the m-th stage, and information stored in advance.

In addition, in a case where the set value P(m) of the pressure in the m-th stage (m is an integer of 1 or more and (n−1) or less and is different from k) is lower than a set value P(m+1) of the pressure in an (m+1)-th stage, the ratio setting unit 716 may not perform the pressure reduction control in the m-th stage. For example, in FIG. 5, since P(2) is lower than P(3), the pressure reduction control is not performed in the second stage. Accordingly, a sudden change in pressure at the start of the third stage can be suppressed.

Next, an example of the screen 761 for automatically setting the time ratio Tr(k) and the pressure ratio ΔPr(k) will be described with reference to FIG. 7. When a third input operation different from the first input operation and the second input operation is performed with the switching button 764, the injection control unit 713 performs the pressure reduction control according to the setting of the ratio setting unit 716. In this case, the switching button 764 displays, for example, “AUTOMATIC” as shown in FIG. 7 under the control of the display control unit 715, and informs the user of the current setting in text.

The display control unit 715 may change display formats of the first input field 762 and the second input field 763 depending on whether Tr(k) and ΔPr(k) are automatically or manually set. For example, background colors of the input fields and color of text are different between FIGS. 6 and 7. The user can be informed of the current setting in a display format.

The switching button 764 is an example of a start button for the injection control unit 713 to perform the pressure reduction control according to the setting of the ratio setting unit 716. As another example of the start button, an energy saving button 765 may be provided. When a desired input operation (for example, pressing) is performed with the energy saving button 765, not only is the pressure reduction control performed but also another control for reducing the power consumption is performed, and all controls for reducing the power consumption in the injection molding machine 10 are performed.

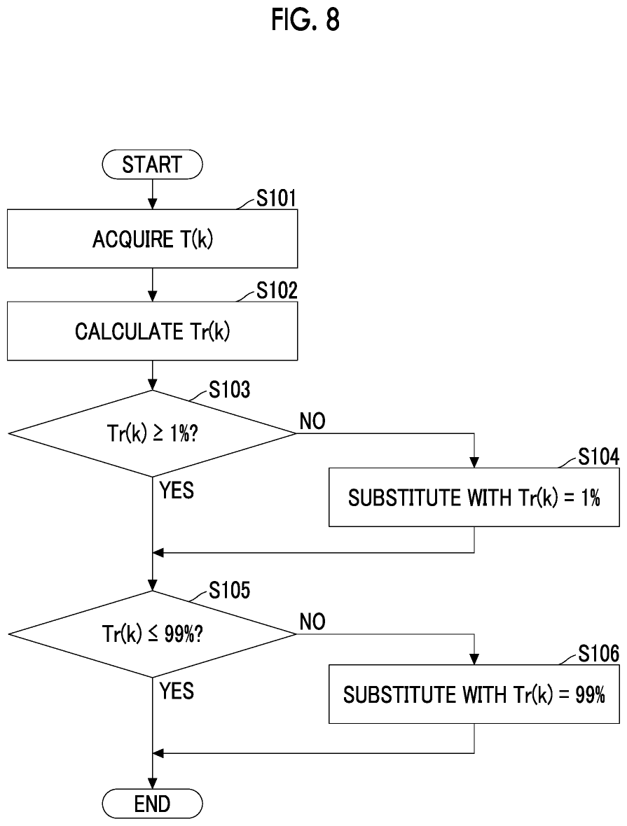

Next, an example of a method of setting the time ratio Tr(k) will be described with reference to FIG. 8. Since a method of setting Tr(m) is the same as the method of setting Tr(k), illustration thereof will be omitted. For example, the ratio setting unit 716 performs steps 5101 to 5106.

First, the ratio setting unit 716 acquires the set value T(k) of the holding time in the k-th stage (step S101). Next, the ratio setting unit 716 calculates the time ratio Tr(k) in the k-th stage (step S102). Tr(k) is calculated using Equation (1) or the like as described above.

Next, the ratio setting unit 716 checks whether or not Tr(k) is equal to or more than a lower limit (for example, 1%) (step S103). In a case where Tr(k) is equal to or more than the lower limit (YES in step S103), the ratio setting unit 716 performs processing after step S105. On the other hand, in a case where Tr(k) is less than the lower limit (NO in step S103), the ratio setting unit 716 changes Tr(k) to the lower limit (step S104), and then performs the processing after step S105.

Next, the ratio setting unit 716 checks whether or not Tr(k) is equal to or less than an upper limit (for example, 99%) (step S105). In a case where Tr(k) is equal to or less than the upper limit (YES in step S105), the ratio setting unit 716 ends the current processing. On the other hand, in a case where Tr(k) is more than the upper limit (NO in step S105), the ratio setting unit 716 changes Tr(k) to the upper limit (step S106), and then ends the current processing.

As described above, the ratio setting unit 716 may set Tr(k) to be in a range of the lower limit or more and the upper limit or less. The lower limit is set so that the pressure reduction control does not start before the actual value of the pressure reaches the target P(k) in the entire cavity space 801. The upper limit is set so as to reduce the power consumption.

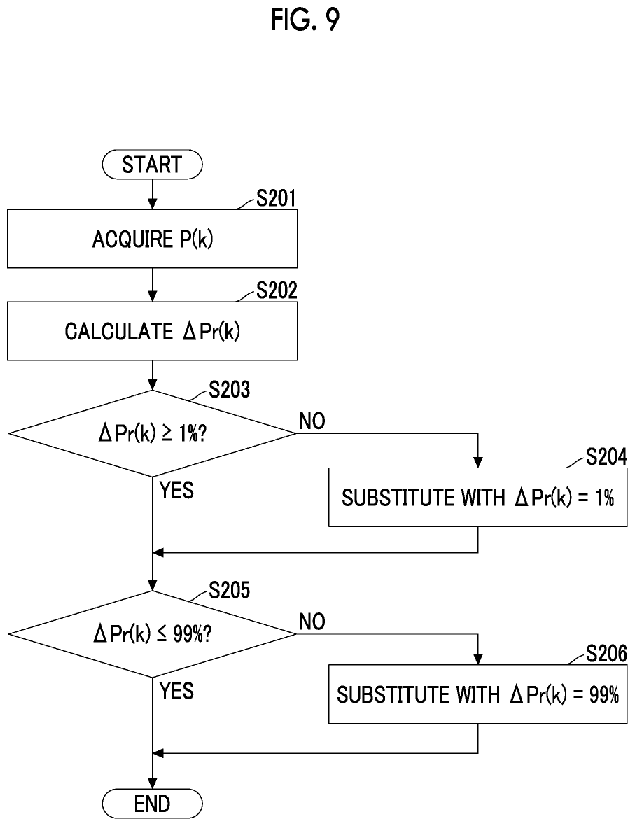

Next, an example of a method of setting the pressure ratio ΔPr(k) will be described with reference to FIG. 9. Since a method of setting ΔPr(m) is the same as the method of setting ΔPr(k), illustration thereof will be omitted. For example, the ratio setting unit 716 performs steps S201 to S206.

First, the ratio setting unit 716 acquires the set value P(k) of the pressure in the k-th stage (step S201). Next, the ratio setting unit 716 calculates the pressure ratio ΔPr(k) in the k-th stage (step S202). ΔPr(k) is calculated using Equations (2) and (3) as described above.

Next, the ratio setting unit 716 checks whether or not ΔPr(k) is equal to or more than a lower limit (for example, 1%) (step S203). In a case where ΔPr(k) is equal to or more than the lower limit (YES in step S203), the ratio setting unit 716 performs processing after step 5205. On the other hand, in a case where ΔPr(k) is less than the lower limit (NO in step S203), the ratio setting unit 716 changes ΔPr(k) to the lower limit (step S204), and then performs the processing after step S205.

Next, the ratio setting unit 716 checks whether or not ΔPr(k) is equal to or less than an upper limit (for example, 99%) (step S205). In a case where ΔPr(k) is equal to or less than the upper limit (YES in step S205), the ratio setting unit 716 ends the current processing. On the other hand, in a case where ΔPr(k) is more than the upper limit (NO in step S205), the ratio setting unit 716 changes ΔPr(k) to the upper limit (step S206), and then ends the current processing.

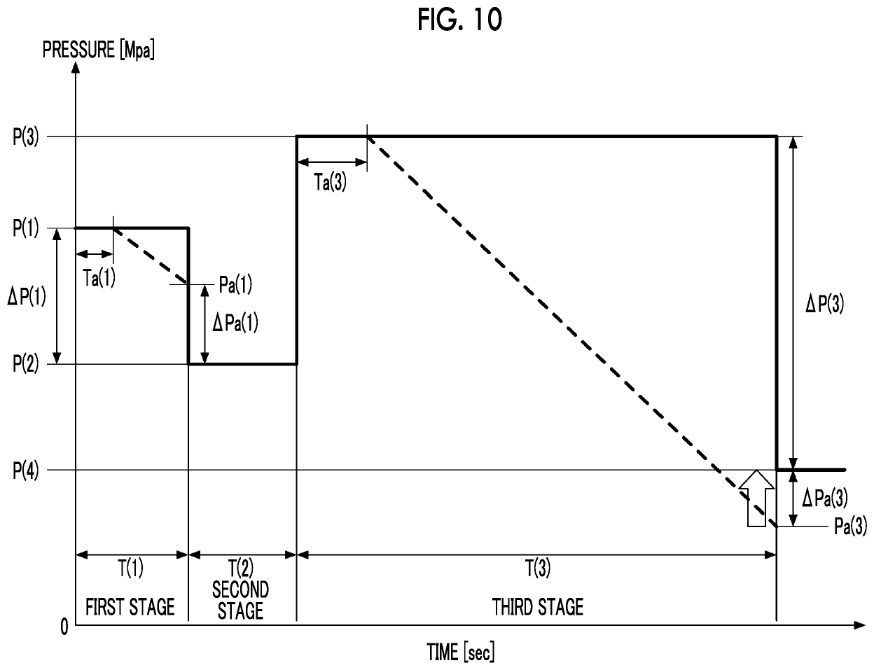

As described above, the ratio setting unit 716 may set ΔPr(k) to be in a range of the lower limit or more and the upper limit or less. The lower limit is set so that the actual value of the pressure does not decrease too much at the end of the k-th stage. The upper limit is set so as to reduce the power consumption. A case where the actual value of the pressure decreases too much at the end of the k-th stage will be described with reference to FIG. 10.

As shown in FIG. 10, in a case where the set value T(k) of the holding time in the k-th stage (for example, the third stage) is long, Pa(k) calculated from Equation (3) becomes lower than a set value P(k+1) of the pressure in the (k+1)-th stage (for example, the fourth stage), and ΔPr(k) calculated from Equation (2) becomes negative.

By setting ΔPr(k) to the lower limit, the ratio setting unit 716 can change the actual value Pa(k) of the pressure at the end of the k-th stage (for example, the third stage) to a value equivalent to the set value P(k+1) of the pressure in the (k+1)-th stage (for example, the fourth stage). For convenience of software programming, Pa(k) is preferably slightly larger than P(k+1), and ΔPr(k) is preferably positive.

Similarly, in a case where k is n, by setting ΔPr(n) to the lower limit, the ratio setting unit 716 can change an actual value Pa(n) of the pressure at the end of an n-th stage to a value equivalent to 0 MPa. For convenience of software programming, Pa(n) is preferably slightly larger than 0 MPa, and ΔPr(n) is preferably positive.

Setting ΔPr(k) to the lower limit is equivalent to correcting the pressure reduction rate V(k) in the k-th stage. The injection control unit 713 performs the pressure reduction control from the middle of the k-th stage to the end of the k-th stage according to the corrected V(k). In a case where the injection control unit 713 does not perform the pressure reduction control from the middle of the k-th stage to the end of the k-th stage, V(k) may not be corrected.

When the pressure actual value reaches the lower limit before the end of the k-th stage by means of the pressure reduction control, the injection control unit 713 may perform the pressure holding control to keep the pressure actual value constant at the lower limit from that point to the end of the k-th stage. The lower limit of the pressure actual value is, for example, the reference value Pt(k). Pt(k) is P(n+1) in a case where k is (n−1) or less, and is 0 MPa in a case where k is n. The lower limit may be larger than the reference value Pt(k).

Hitherto, the embodiments of the control device of an injection molding machine, the injection molding machine, and the method of controlling an injection molding machine according to the present invention have been described. However, the present invention is not limited to the above-described embodiments. Various modifications, corrections, substitutions, additions, deletions, and combinations can be made within the scope of the appended claims. As a matter of course, all of these also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. A control device of an injection molding machine including an injection member that presses a molding material and an injection drive source that moves the injection member, the control device comprising:
an injection control unit that controls, in a pressure holding process of controlling a pressure acting on the molding material from the injection member, the injection drive source based on a set value of the pressure and on an actual value of the pressure,
wherein the pressure holding process has n stages (n is an integer of 1 or more) of combinations of set values of the pressure and holding times for holding the set values,
the injection control unit performs pressure reduction control to gradually reduce the actual value of the pressure with respect to the set value of the pressure from a middle of a k-th stage (k is an integer of 1 or more and n or less),
the control device further comprises a ratio setting unit that sets a time ratio Tr(k) in the k-th stage and a pressure ratio ΔPr(k) in the k-th stage based on a set value P(k) of the pressure in the k-th stage, on a set value T(k) of the holding time in the k-th stage, and on information stored in advance,
where Tr(k) is a ratio of a start time Ta(k) at which the pressure reduction control starts in the k-th stage to the set value T(k) of the holding time in the k-th stage, and
where ΔPr(k) is a ratio of a difference ΔPa(k) between the actual value of the pressure at an end of the k-th stage and a reference value to a difference ΔP(k) between the set value P(k) of the pressure in the k-th stage and the reference value.

2. The control device of an injection molding machine according to claim 1,
wherein the ratio setting unit uses the same value as the time ratio Tr(k) in the k-th stage as a time ratio Tr(m) in an m-th stage (m is an integer of 1 or more and n or less and is different from k), and uses the same value as the pressure ratio ΔPr(k) in the k-th stage as a pressure ratio ΔPr(m) in the m-th stage.

3. The control device of an injection molding machine according to claim 1,
wherein the ratio setting unit sets a time ratio Tr(m) in an m-th stage (m is an integer of 1 or more and n or less and is different from k) and a pressure ratio ΔPr(m) in the m-th stage based on a set value P(m) of the pressure in the m-th stage, on a set value T(m) of the holding time in the m-th stage, and on information stored in advance.

4. The control device of an injection molding machine according to claim 1,
wherein, in a case where a set value P(m) of the pressure in an m-th stage (m is an integer of 1 or more and (n−1) or less and is different from k) is lower than a set value P(m+1) of the pressure in an (m+1)-th stage, the ratio setting unit does not perform the pressure reduction control in the m-th stage.

5. The control device of an injection molding machine according to claim 1, further comprising:
a display control unit that displays, on a display device, a start button for the injection control unit to perform the pressure reduction control according to setting of the ratio setting unit.

6. An injection molding machine comprising:
the control device according to claim 1;
the injection member; and
the injection drive source.

7. A method of controlling an injection molding machine including an injection member that presses a molding material and an injection drive source that moves the injection member, the method comprising:
an injection control process of, in a pressure holding process of controlling a pressure acting on the molding material from the injection member, controlling the injection drive source based on a set value of the pressure and on an actual value of the pressure,
wherein the pressure holding process has n stages (n is an integer of 1 or more) of combinations of set values of the pressure and holding times for holding the set values, the injection control process has a pressure reduction control process of gradually reducing the actual value of the pressure with respect to the set value of the pressure from a middle of a k-th stage (k is an integer of 1 or more and n or less),
the control method further comprises a ratio setting process of setting a time ratio Tr(k) in the k-th stage and a pressure ratio ΔPr(k) in the k-th stage based on a set value P(k) of the pressure in the k-th stage, on a set value T(k) of the holding time in the k-th stage, and on information stored in advance,
where Tr(k) is a ratio of a start time Ta(k) at which the pressure reduction control process starts in the k-th stage to the set value T(k) of the holding time in the k-th stage, and
where ΔPr(k) is a ratio of a difference ΔPa(k) between the actual value of the pressure at an end of the k-th stage and a reference value to a difference ΔP(k) between the set value P(k) of the pressure in the k-th stage and the reference value.
